(19) United States
(12) Patent Application Publication
(10) Pub. No.: US 2008/0313275 A1
(43) Pub. Date: Dec. 18, 2008

(54) Method and System For Implementing Ring Service of Instant Messaging

(75) Inventors: Chaojin Luo, Guangdong (CN); Maohua Hu, Guangdong (CN); Youyao Lin, Guangdong (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited, Shenzhen (CN)

(21) Appl. No.: 11/578,531

(22) PCT Filed: Feb. 28, 2005
(86) PCT No.: PCT/CN2005/000249

§ 371 Date: Jul. 20, 2007

(30) Foreign Application Priority Data
Feb. 26, 2004 (CN) 200410003195.1

(51) Int. Cl. G06F 15/16

(52) U.S. Cl. 709/204

(57) ABSTRACT

The present invention discloses a method and system for implementing ring service of IM. The system comprises at least a ring server, a ring user database and a ring file server to realize ring service. The method comprises: configuring, by an IM client A, a ring relationship between messaging events of the IM client A and rings played by an IM client B; acquiring, by the IM client B, the ring relationship; acquiring, by the IM client B, a ring file corresponding to a messaging event of the IM client A according to the ring relationship, and playing the ring file.

### FIELD OF THE TECHNOLOGY

The present invention relates to network instant messaging (IM) technology, and particularly, to a method and a system for implementing a ring service of IM.

### BACKGROUND OF THE INVENTION

At present, IM services based on a network have been applied more and more along with the increasing popularization of networks. IM mainly implements an instant messaging function in the network. A user can implement the instant messaging through the network using an IM service. Furthermore, the IM service has gradually extended to a tendency of combining with network virtual community, which makes the IM service to be applied more widely. In an IM service, the two parties communicating with each other build a friend relationship in general, that is, an IM client sets other IM clients that the IM client often contacts to friends of the IM client such that it is convenient for the IM communication. As shown in FIG. 1, for the instance that there are two IM users, that is, IM client A and IM client B, a IM server in the network is used for storing basic profile of IM users including IM client A and IM client B, and building and managing a connection through a network, with which IM client A and IM client B implement an instant messaging, between IM client A and IM client B.

In the IM service, a user is prompted a messaging event occurred currently though a prompt voice in general. For example, a user is prompted through sending a prompt voice to the user that another client of the IM service logs in or logs out, or another user is sending a message to the user. However, the prompt voices sent to users by the IM service are invariable in the prior art, which not only results in blankness and insipidity of the prompt voices, but also cannot distinguish different messaging events, such as login, logout and sending a message, using the prompt voices. In addition, the prompt voices provided by the IM service in the prior art cannot meet a customized demand of an IM service user, that is, implement customizing a customized ring on the request of the user. Thereby, this limits the quality of service of the IM service.

### SUMMARY OF THE INVENTION

The present invention provides a method and system for implementing customized ring service of IM, playing different prompt rings preconfigured according to different messaging events of the IM user and customizing the prompt rings according to the customized demand of the IM user, thereby improving the quality of IM service.

A method for implementing ring service of Instant Messaging (IM) comprises:

configuring, by an IM client A, a ring relationship between messaging events of the IM client A and rings played by an IM client B;

acquiring, by the IM client B, the ring relationship;

acquiring, by the IM client B, a ring file corresponding to a messaging event of the IM client A according to the ring relationship, and playing the ring file.

Wherein, said configuring by the IM client A a ring relationship between messaging events of the IM client A and rings selected by the client B for playing comprises:

selecting, by the IM client A, the IM client B;

sending, by the IM client A, a request for configuring the rings for the IM client B to a ring data management module of a ring server;

acquiring, by the ring data management module, ring file information available for selection from the ring file server, and providing the ring file information for the IM client A;

selecting, by the IM client A, the ring played by the IM client B according to the ring file information provided by the ring data management module, configuring the ring relationship between the rings and the messaging events of the IM client A;

storing, by the IM client A, the ring relationship to a ring user database.

The method further comprises:

Transmitting, by the IM client B, the ring file customized by the IM user to the ring file server via the ring data management module;

storing, by the ring file server, the customized ring file as the ring file available for selection.

Wherein, said acquiring by the IM client B the ring relationship comprises:

Sending, by the IM client B, a request for acquiring the ring relationship to a user profile management module of the ring server after logging on an IM system;

upon receiving the request, acquiring, by the user profile management module, the ring relationship from a ring user database, and returning the ring relationship to the IM client B.

Wherein, said acquiring by the IM client B the ring file corresponding to the messaging event of the IM client A according to the ring relationship and playing the ring file comprises:

upon acquiring the current messaging event of the IM client A, deciding, by the IM client B, whether there exists the ring corresponding to the messaging event in the ring relationship, and if determined that there exists the ring,

playing, by the IM client B, the ring file if the ring file exists in itself; or

acquiring, by the IM client B, from a ring file server and playing the ring file if the ring file does not exist in itself.

Wherein, said acquiring by the IM client B the ring file from the ring file server comprises:

sending, by the IM client B, a request for acquiring the ring file to a ring data management module of a ring server;

acquiring, by the ring data management module, the ring file from the ring file server according to the received request, and returning the ring file to the IM client B.

Wherein, said sending by the IM client the request to the ring data management module or the user profile management module of the ring server comprises:

sending, by the IM client, the request to an IM client request receiving module of the ring server;

upon receiving the requests, forwarding, by the IM client request receiving module, the request to an IM client request processing module of the ring server;

processing, by the IM client request processing module, the request and sending the processed request to the ring data management module or the user profile management module.

Wherein, said sending by the IM client the request to the IM client request receiving module of the ring server comprises:

sending, by the IM client, the request to the IM client request receiving module in the encrypted communication mode;

said processing by the IM client request processing module the request comprising:

decrypting, by the IM client request processing module, the request, and generating a packet for the request identifiable by the ring data management module or the user profile management module.

Wherein, the IM client A comprises at least two IM clients, and/or, the IM client B comprises at least two IM clients.

The method further comprises:

setting, by the IM client A, the IM client B as a friend before configuring the ring relationship between messaging events of the IM client A and rings played by an IM client B.

Wherein, the messaging event of the IM client A comprises:

login of the IM client A, logout of the IM client A or sending by the IM client A a message to the IM client B.

A system for implementing ring service of Instant Messaging comprises an IM client A, an IM client B and an IM server, wherein the IM server creates and manages connection between the IM client A and the IM client B by which they implement instant messaging with each other, and

the system further comprises: a ring server, a ring user database and a ring file server, wherein:

the IM client A configures a ring relationship between messaging events of the IM client A and rings played by an IM client B;

the ring server receives the ring relationship and sends the ring relationship to the ring user database;

the ring user database stores the ring relationship;

the IM client B acquires the ring relationship from the ring user database via the ring server and acquires the ring file for playing from the ring file server according to the ring relationship;

the ring file server stores the ring file.

Wherein, said acquiring by the IM client B the ring file for playing from the ring file server according to the ring relationship comprises:

upon acquiring the messaging event of the IM client A, the IM client B acquires the ring file for playing from the ring file server via the ring server according to the ring relationship between the messaging event and the ring.

Wherein, the ring server comprises at least one of: a ring data management module and a user profile management module;

the ring data management module acquires the ring file from the ring file server, and provides the ring file for the IM client B;

the user profile management module sends the received ring relationship to the ring user database, acquires the ring relationship from the ring user database and returns the ring relationship to the IM client B.

Wherein, the ring server further comprises: an IM client request receiving module and an IM client request processing module;

the IM client request receiving module receives a request sent by the IM client, and forwards the request to the IM client request processing module;

after processing the request, the IM client request processing module sends the processed request to the ring data management module or the user profile management module to perform the corresponding processing.

Wherein, the ring user database and the ring file server are integrated in the ring server.

Wherein, the IM client A and/or the IM client B comprise at least two IM clients.

It can be seen from the above-mentioned scheme that, in the method and system for implementing ring service of IM provided by this invention, the IM user sets a customized ring and the ring relationship thereof for a friend, as the IM user runs some messaging events such as login, logout and sending the message, the friend selects the corresponding ring to play according to the ring relationship, thereby implementing that the different rings are played according to the different messaging events, acquiring more rich and colorful ring prompts by the IM user and increasing the variety of messaging mode between IM users, which improves the quality of IM service. In addition, this invention not only can use each fashion ring as the ring played by the IM user, but also can use the ring customized by the IM user as the played ring, which makes it possible that the IM user can acquire more customized services, thereby improving the quality of service of IM service.

### BRIEF DESCRIPTION OF THE DRAWINGS

FIG. 1 shows a schematic diagram of a system for implementing an IM service in the prior art.

FIG. 2 shows a schematic diagram of a system for implementing a ring service of IM in accordance with the present invention.

FIG. 2 shows a schematic diagram of modules of a ring server in accordance with the present invention.

FIG. 4 shows the flow chart for implementing a ring service of IM in an embodiment of the present invention.

FIG. 5 shows a flow chart for setting by a client ring relationships for a friend of the IM client in an embodiment of the present invention.

FIG. 5 shows a flow chart for acquiring by an IM client ring relationships in an embodiment of the present invention.

FIG. 7 shows a flow chart for choosing by an IM client a corresponding ring to play in an embodiment of the present invention.

### DETAILED DESCRIPTION OF THE INVENTION

The present invention provides a method and a system for implementing a ring service of IM. In the method, an IM user sets rings and ring relationships for a friend of the IM user, the friend acquires the ring relationships, and a ring is chosen to be played according to the ring relationships based on a messaging event of the IM user occurred currently. Thus, the ring service in the IM is implemented. In the system, a ring server, a ring user database and a ring file server are newly added to a network in which an IM service is implemented. An IM client sets and stores ring relationships in the ring user database through the ring server, or acquires ring relationships from the ring user database through the ring server. Ring files which can be chosen by an IM client are stored in the ring file server. An IM client acquires a corresponding ring file from the ring file server through the ring server and also can send a customized ring file set to the ring file server to be stored through the ring server.

The present invention is hereinafter described in detail with reference to the accompanying drawings.

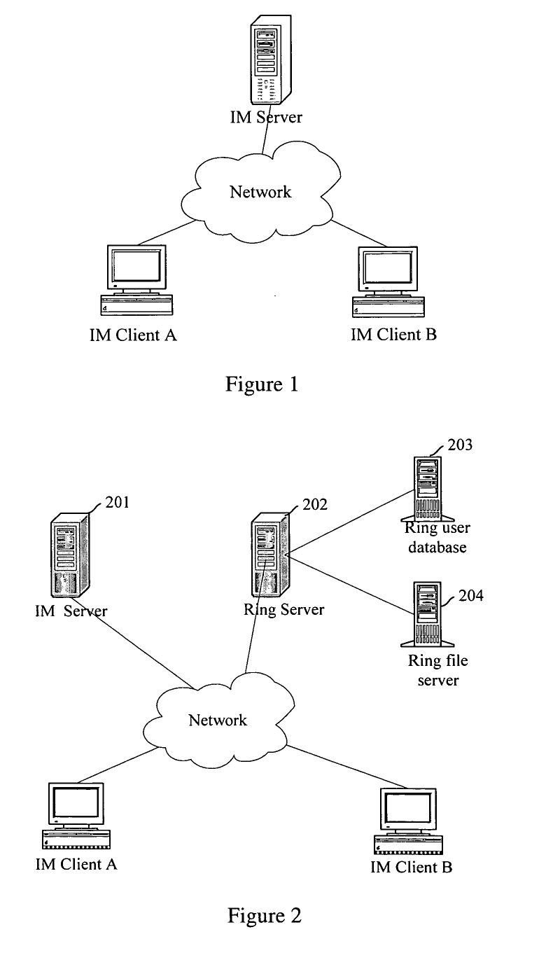

As shown in FIG. 2, a system for implementing a customized ring service in IM provided by the present invention is acquired by newly adding a ring server, a ring user database and a ring file server to a system for implementing an IM service as shown in FIG. 1. In the embodiments of the present invention, the system for implementing the customized ring service in IM includes IM server 201, ring server 202, ring user database 203, ring file server 204, as well as IM clients implementing instant messaging though the network which are to be described only by the examples of IM client A and IM client B for simple describing in the embodiments of the present invention. Ring server 202 serves as a customized ring server. Ring user database serves as a customized ring user database.

Ring user database 203 shown in FIG. 2 is used for storing basic profile of IM clients that have opened the ring service and storing ring relationships for their friends set by the IM clients that have opened the ring service.

Ring file server 204 shown in FIG. 2 is used for storing various kinds of ring file including the ring files contained by the system, as well as ring files uploaded to the ring file server after customized by the IM clients.

Ring server 202 is used for implementing functions as follows:

(1) processing the opening/closing of the ring service by a IM client: when a IM client opens the ring service, the ring server stores the basic profile of the client in ring user database 203, and when a IM client closes the ring service, the ring server deletes the basic profile of the client in the ring user database 203.

(2) processing a request of an IM client for setting ring relationships for a friend of the IM client: ring server 202 stores data of ring relationships for the friend of the IM client in ring user database 203 according to the request for setting ring relationships for the friend of the IM client sent by the IM client.

(3) transmitting the data of ring relationships for the friend of the IM client and ring files to a local computer of the IM client: the ring server is capable of acquiring ring relationships for the friend of the IM client from ring user database 203 and transmitting the ring relationships to the local computer of the IM client, acquiring data of ring files of a friend of the IM client from the ring file server and transmitting the data of ring files to the local computer of the IM client, and transmitting a ring file defined by the IM client to ring file server 204.

As shown in FIG. 3, ring server 202 is implemented by the following modules: IM client request receiving module 301, IM client request processing module 302, user profile management module 303 and ring data management module 304.

IM client request receiving module 301 is used for receiving a request sent by an IM client, which includes a request for acquiring data of ring relationships and a request for acquiring a ring file. IM client request receiving module 301 forwards the request to IM client request processing module 302 to process upon receiving the request. After processing the request, IM client request processing module 302 sends the request processed to user profile management module 303 or ring data management module 304. The IM client request processing module 302 performs the following processing: generating a packet identifiable by the user profile management module for the request sent by the IM client, as well as decrypting a request sent in an encrypted mode.

User profile management module 303 is used for setting data of ring relationships in ring user database 203 shown in FIG. 2 according to the content in the received request sent by the IM client, and acquiring the corresponding data of ring relationships from ring user database 203 shown in FIG. 2 and returning the data of ring relationships to the IM client that sent the request.

Ring data management module 304 is used for acquiring the corresponding ring file from ring file server 204 shown in FIG. 2 according to the content in the received request sent by the IM client and returning the ring file to the IM client that sent the request.

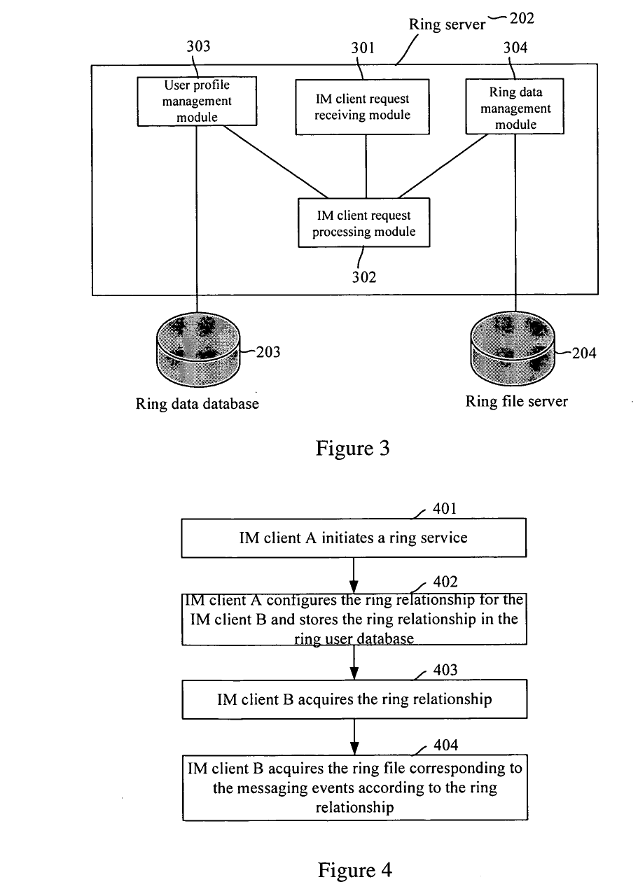

As shown in FIG. 4, the method to implement a ring service of IM in accordance with an embodiment of the present invention includes the following steps, taking an example in which two IM parties are IM client A and IM client B:

Step 401: The IM client A initiates a ring service, in accordance with the embodiment of the present invention, the IM client A initiates the ring service via a ring server, and the ring server saves basic profile of the IM client A in a ring user database.

Step 402: The IM client A sets ring relationship data for its friend IM client B, and saves the ring relationship data in the form of a file in the ring user database shown in FIG. 2. In the embodiment of the present invention, the IM client A sets the following ring relationship data for the IM client B.

When the IM client A logins, the IM client B determines the messaging event above has happened, and selects ring-1 to be played. In the embodiment of the present invention, the ring-1 is MIDI-1.

When the IM client A sends an instant communication message to the IM client B, the IM client B determines the messaging event above has happened, and selects ring-2 to be played. In the embodiment of the present invention, the ring-2 is MIDI-2.

When the IM client A logouts, the IM client B determines the messaging event above has happened, and selects ring-3 to be played. In the embodiment of the present invention, the ring-3 is MIDI-3.

In the embodiment of the present invention, the ring relationship data mentioned above are saved in the form of a ring relationship data file, and the data format is:

the number of IM client A+the number of IM client B+type of the messaging event+number of ring identifier (ring ID).

If the IM client B is not a friend of the IM client A in an initial state, the IM client A will set the IM client B as its friend before executing the step.

Step 403: Upon logging on the IM system, the IM client B obtains the ring relationship data from the ring relationship database via the ring server shown in FIG. 2, and the ring relationship data include the ring relationship data set for the IM client B by the IM client A. In this embodiment, after logging on the IM system, the IM client B sends a request to the ring server asking for obtaining the ring relationship data set for it by the IM client A. Upon receiving the request, the ring server obtains the ring relationship data file set by the IM client A from the ring user database, and transmits the ring relationship data file to the IM client B.

Step 404: The IM client B obtains the corresponding ring file and play it according to the ring relationship data received in step 403, based on the current messaging event In this embodiment, if the IM client B determines that the messaging event indicating the login of the IM client A has occurred, the IM client B selects MIDI-1 to be played according to the settings of the ring relationship data; if the IM client B determines that the messaging event indicating the IM client A sending a message to the IM client B has occurred, the IM client B selects MIDI-2 to be played according to the settings of the ring relationship data; if the IM client B determines that the messaging event indicating the logout of the IM client A has occurred, the IM client B selects MIDI-3 to be played according to the settings of the ring relationship data If the IM client B has used the MIDI-1, MIDI-2 or MIDI-3, the ring files corresponding to the above ring are saved in the IM client B. If the IM client B has not used at least one of the three ring, the IM client B obtains the corresponding ring file via the ring server shown in FIG. 2 according to the following steps:

The IM client B sends a request for obtaining the ring file to the ring server according to the ring file ID corresponding to the ring relationship data. Upon receiving the request, the ring server obtains the corresponding ring file from the ring file server according to the ring file ID carried in the request, then the ring server sends the ring file to the IM client B;

The above-mentioned embodiments only relate to the implementation of the IM ring service between the IM client A and the IM client B, and the objective of the description is to depict the invention. The description, however, is not used for limiting the protection scope of the present invention. In other embodiments of the present invention, the IM client A and/or the IM client B can be supposed to be multiple IM clients, and in this way, the invention can also implement the ring service in accordance with the solution put forward by the above-mentioned embodiments, to implement the IM ring service among multiple IM clients. In addition, the embodiments of the present invention can play different rings for different messaging events, and the implementation is the same as the that of the above-mentioned embodiments.

A detailed description will be given with reference to the accompanying drawing to clarify the steps shown in FIG. 4.

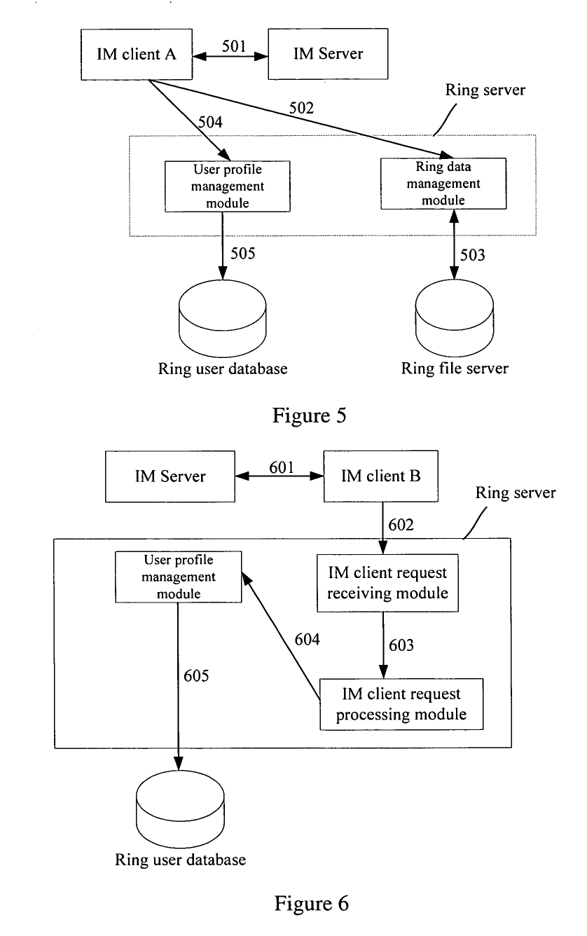

As shown in FIG. 5, a detailed implementation of setting ring relationship data by the IM client A mentioned in step 402 for his/her friend IM client B will be described in detail hereinafter.

Step 501: the IM client A sends a login request to the IM server shown in FIG. 2. The IM server authenticates the IM client A after receiving the login request. If the authentication succeeds, the IM client A is allowed to log in the IM system.

Step 502: after logging in the IM system, the IM client A selects the IM client B as his/her friend on the man-machine interface provided by the IM system. Then the IM client A sends a ring setting request to the ring data management module in the ring server shown in FIG. 2, requesting to set a ring for the IM client B.

Step 503: after receiving the ring setting request from the IM client A, the ring data management module in the ring server provides every ring file in the ring file server shown in FIG. 2 for the IM client A to select. In the embodiment of the present invention, the ring data management module in the ring server displays information, such as type, name, click rate, etc. of each available ring file in a Hyper Text Mark Language (HTML) page, so as to facilitate the selection for the IM client A. In other embodiments of the present invention, the information of the ring files can also be displayed by other means, which has no impact on the implementation of the present invention.

Step 504: the IM client A selects a corresponding ring file from those displayed in step 503, then sets ring relationship data between the selected ring file and a messaging event of the IM client A which possibly happens. And then the IM client A sends a ring relationship data setting request to the user profile management module in the ring server, so as to store the set ring relationship data to the ring user database shown in FIG. 2 through the ring server.

Step 505: after receiving the ring relationship data setting request sent in step 504, the user profile management module in the ring server stores the ring relationship data into the ring user database shown in FIG. 2 according to the received ring relationship data setting request.

In the embodiment of the present invention, an IM client can also adopt a customized ring. To achieve that, the IM client can upload his/her customized ring file to the ring data management module shown in FIG. 5. The ring data management module stores the received ring file into the ring file server to provide for the user.

As shown in FIG. 6, the step of the IM client B acquiring the ring relationship data mentioned in step 403 will be described in detail hereinafter.

Step 601: the IM client B sends a login request to the IM server. After receiving the login request, the IM server authenticates the IM client B, if the authentication succeeds, the IM client B is allowed to log in the IM system.

Step 602: the IM client B sends an inquiry ring relationship data request to the IM client request receiving module in the ring server shown in FIG. 2 to obtain the ring relationship data set by each IM client, including the IM client A, for their respective friend. In the embodiment of the present invention, the inquiry ring relationship data is sent to the IM client request receiving module by means of encrypted communication. In other embodiments of the present invention, other communication methods are also applicable, which has no impact on the implementation of the present invention.

Step 603: after receiving the inquiry ring relationship data request sent in step 602, the IM client request receiving module forwards the inquiry ring relationship data request to the IM client request processing module in the ring server shown in FIG. 2.

Step 604: after receiving the inquiry ring relationship data request sent in step 603, the IM client request processing module transforms the inquiry ring relationship data request into a packet that can be recognized by the user profile management module, and then sends the packet to the user profile management module. In the embodiment of the present invention, since the encrypted communication is adopted by the IM client B to send the inquiry ring relationship data request to the IM client request receiving module in step 602, in this step, the IM client request processing module needs to decrypt the received inquiry ring relationship data request first, and then transforms the decrypted inquiry ring relationship data request into a packet that can be recognized by the user profile management module.

Step 605: the user profile management determines that it is the IM client B that inquires the ring relationship data according to the received packet, and then obtains from the ring user database shown in FIG. 2 the ring relationship data set for the IM client B by each friend of the IM client B including the IM client A. Then the user profile management module returns the obtained ring relationship data to the IM client B. In the embodiment of the present invention, the user profile management module returns the obtained ring relationship data to the IM client B by packing the ring relationship data file. In other embodiments of the present invention, other methods can also be adopted to return the ring relationship data to the IM client B, which has no impact on the implementation of the present invention.

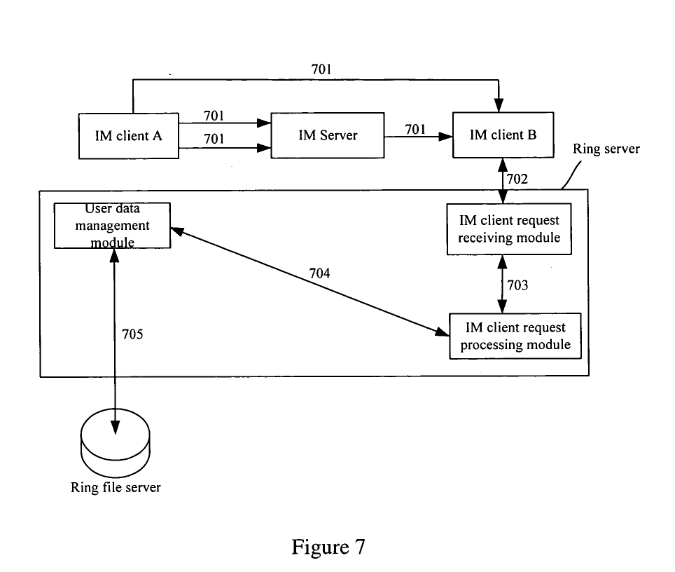

Referring to FIG. 7, the process of the IM client B selecting the corresponding ring according to the current messaging event and playing the ring in step 404 will be described in detail. In this scenario, the IM client B should log in the IM server before the following steps continue.

Step 701: The IM client B acquires the current messaging event of the IM client A, and according to which, decides whether there is a ring relationship data corresponding to the current messaging event in the obtained ring relationship data. If there is a corresponding ring relationship data, the IM client B determines a ring ID corresponding to the current messaging event from the ring relationship data and decides whether a ring file corresponding to the ring ID is stored in itself. If the IM client B has the ring file stored in itself, it plays the ring file to implement a ring service and then ends the flow; otherwise, step 702 and the subsequent steps are performed.

Step 702: The IM client B sends a request acquiring the ring file to the IM client request receiving module of the ring server shown in FIG. 2. The request contains the ring ID determined in Step 701. In an embodiment of the present invention, the request is sent to the ring server in an encrypted communication mode. In another embodiment of the present invention, the request may be sent to the ring server in other ways as long as the present invention can be implemented.

Steps 703˜704: The IM client request receiving module forwards the received request acquiring the ring file to an IM client request processing module of the ring server. The IM client request processing module encrypts the request, generates a packet for the request identifiable to a ring data management module, and then sends the packet to the ring data management module. In this case, the packet contains the ring ID determined in Step 701.

Step 705: According to the ring ID in the received packet generated for the request, the ring data management module acquires the ring file corresponding to the ring ID from the ring file server shown in FIG. 2 and returns the ring file to the IM client B. The IM client B plays the received ring file to implement the ring service and then ends the flow. In an embodiment of the present invention, the ring data management module returns the ring file to the IM client B using a packet manner. In another embodiment of the present invention, the ring file may be returned to the IM client B in other ways as long as the present invention can be implemented.

The foregoing is only the preferred embodiments of the present invention and is not intended to limit the scope of the present invention. Any modification, equivalent substitution, or improvement made without departing from the spirit and principle of the present invention should be covered by the scope set forth in the appended claims.

1.-17. (canceled)

18. A method for implementing ring service of Instant Messaging (IM), characterized in that the method comprises:
configuring, by an IM client A, ring relationship between messaging events of the IM client A and rings played by an IM client B;
acquiring, by the IM client B, the ring relationship;
acquiring, by the IM client B, a ring file corresponding to a messaging event of the IM client A according to the ring relationship, and playing the ring file.

19. The method according to claim 18, wherein said configuring by the IM client A a ring relationship between messaging events of the IM client A and rings selected by the client B for playing comprises:
selecting, by the IM client A, the IM client B;
sending, by the IM client A, a request for configuring the rings for the IM client B to a ring data management module of a ring server;
acquiring, by the ring data management module, ring file information available for selection from the ring file server, and providing the ring file information for the IM client A;
selecting, by the IM client A, the ring played by the IM client B according to the ring file information provided by the ring data management module, configuring the ring relationship between the rings and the messaging events of the IM client A;
storing, by the IM client A, the ring relationship to a ring user database.

20. The method according to claim 19, further comprising:
transmitting, by the IM client B, the ring file customized by the IM user to the ring file server via the ring data management module;
storing, by the ring file server, the customized ring file as the ring file available for selection.

21. The method according to claim 18, wherein said acquiring by the IM client B the ring relationship comprises:
sending, by the IM client B, a request for acquiring the ring relationship to a user profile management module of the ring server after logging in an IM system;
upon receiving the request, acquiring, by the user profile management module, the ring relationship from a ring user database, and returning the ring relationship to the IM client B.

22. The method according to claim 18, wherein said acquiring by the IM client B the ring file corresponding to the messaging event of the IM client A according to the ring relationship and playing the ring file comprises:
upon acquiring the current messaging event of the IM client A, deciding, by the IM client B, whether there exists the ring corresponding to the messaging event in the ring relationship, and if determined that there exists the ring,
playing, by the IM client B, the ring file if the ring file exists in itself; or
acquiring, by the IM client B, from a ring file server and playing the ring file if the ring file does not exist in itself.

23. The method according to claim 22, wherein said acquiring by the IM client B the ring file from the ring file server comprises:
sending, by the IM client B, a request for acquiring the ring file to a ring data management module of a ring server;
acquiring, by the ring data management module, the ring file from the ring file server according to the received request, and returning the ring file to the IM client B.

24. The method according to claim 19, wherein said sending by the IM client the request to the ring data management module or the user profile management module of the ring server comprises:
sending, by the IM client, the request to an IM client request receiving module of the ring server;
upon receiving the requests, forwarding, by the IM client request receiving module, the request to an IM client request processing module of the ring server;
processing, by the IM client request processing module, the request and sending the processed request to the ring data management module or the user profile management module.

25. The method according to claim 24, wherein said sending by the IM client the request to the IM client request receiving module of the ring server comprises:
sending, by the IM client, the request to the IM client request receiving module in the encrypted communication mode;
said processing by the IM client request processing module the request comprising:
decrypting, by the IM client request processing module, the request, and generating a packet for the request identifiable by the ring data management module or the user profile management module.

26. The method according to claim 21, wherein said sending by the IM client the request to the ring data management module or the user profile management module of the ring server comprises:
sending, by the IM client, the request to an IM client request receiving module of the ring server;
upon receiving the requests, forwarding, by the IM client request receiving module, the request to an IM client request processing module of the ring server;
processing, by the IM client request processing module, the request and sending the processed request to the ring data management module or the user profile management module.

27. The method according to claim 26, wherein said sending by the IM client the request to the IM client request receiving module of the ring server comprises:
sending, by the IM client, the request to the IM client request receiving module in the encrypted communication mode;
said processing by the IM client request processing module the request comprising:
decrypting, by the IM client request processing module, the request, and generating a packet for the request identifiable by the ring data management module or the user profile management module.

28. The method according to claim 23, wherein said sending by the IM client the request to the ring data management module or the user profile management module of the ring server comprises:
sending, by the IM client, the request to an IM client request receiving module of the ring server;
upon receiving the requests, forwarding, by the IM client request receiving module, the request to an IM client request processing module of the ring server;
processing, by the IM client request processing module, the request and sending the processed request to the ring data management module or the user profile management module.

29. The method according to claim 28, wherein said sending by the IM client the request to the IM client request receiving module of the ring server comprises:
sending, by the IM client, the request to the IM client request receiving module in the encrypted communication mode;
said processing by the IM client request processing module the request comprising:
decrypting, by the IM client request processing module, the request, and generating a packet for the request identifiable by the ring data management module or the user profile management module.

30. The method according to claim 18, wherein the IM client A comprises at least two IM clients, and/or, the IM client B comprises at least two IM clients.

31. The method according to claim 18, further comprising:
setting, by the IM client A, the IM client B as a friend before configuring the ring relationship between messaging events of the IM client A and rings played by an IM client B.

32. The method according to claim 18, wherein the messaging event of the IM client A comprises:
login of the IM client A, logout of the IM client A or sending by the IM client A a message to the IM client B.

33. A system for implementing ring service of Instant Messaging, comprising an IM client A, an IM client B and an IM server, wherein the IM server creates and manages connection between the IM client A and the IM client B by which they implement instant messaging with each other, characterized in that
the system further comprising: a ring server, a ring user database and a ring file server, wherein:
the IM client A configures a ring relationship between messaging events of the IM client A and rings played by an IM client B;
the ring server receives the ring relationship and sends the ring relationship to the ring user database;
the ring user database stores the ring relationship;
the IM client B acquires the ring relationship from the ring user database via the ring server and acquires the ring file for playing from the ring file server according to the ring relationship;
the ring file server stores the ring file.

34. The system according to claim 33, wherein said acquiring by the IM client B the ring file for playing from the ring file server according to the ring relationship comprises:
upon acquiring the messaging event of the IM client A, the IM client B acquires the ring file for playing from the ring file server via the ring server according to the ring relationship between the messaging event and the ring.

35. The system according to claim 33, wherein the ring server comprises at least one of: a ring data management module and a user profile management module;
the ring data management module acquires the ring file from the ring file server, and provides the ring file for the IM client B;
the user profile management module sends the received ring relationship to the ring user database, acquires the ring relationship from the ring user database and returns the ring relationship to the IM client B.

36. The system according to claim 35, wherein the ring server further comprises: an IM client request receiving module and an IM client request processing module;
the IM client request receiving module receives a request sent by the IM client, and forwards the request to the IM client request processing module;
after processing the request, the IM client request processing module sends the processed request to the ring data management module or the user profile management module to perform the corresponding processing.

37. The system according to claim 33, wherein the ring user database and the ring file server are integrated in the ring server.

38. The system according to claim 33, wherein the IM client A and/or the IM client B comprise at least two IM clients.
